(19) United States
(12) Patent Application Publication
(10) Pub. No.: US 2010/0318443 A1
(43) Pub. Date: Dec. 16, 2010

(54) APPARATUS FOR ASSESSING AND METHOD FOR DELIVERING AN EQUIPMENT UPGRADE PROPOSAL

(76) Inventor: CHRISTOPHER MICHAEL CULP, Shelbyville, IN (US)

Correspondence Address: Meiers Law Office, 7245 Sawmill Run, Holland, OH, 43528, US

(21) Appl. No.: 12/815,936

(22) Filed: Jun. 15, 2010

Related U.S. Application Data
(60) Provisional application No. 61/187,398, filed on Jun. 16, 2009.

(51) Int. Cl. G06Q 30/00; G06Q 10/00; G06Q 50/00; G06F 12/02

(52) U.S. Cl. 705/27; 705/348; 711/103; 711/E12.008

(57) ABSTRACT

A computer-implemented method for delivering an equipment upgrade proposal is disclosed herein. The computer-implemented method includes the step of receiving input related to the nature of use of current equipment. The computer-implemented method also includes the step of estimating a payback period based on the received input. The computer-implemented method also includes the step of displaying textual information detailing the payback period for consideration by a potential customer. The computer-implemented method also includes the step of generating a plurality of different screen displays including at least one screen display during the receiving step and at least one screen display during the displaying step. The computer-implemented method also includes the step of customizing at least one of the plurality of different screen shots based on information associated with the potential customer other than the input related to the nature of use of current equipment. An apparatus for practicing the method and a readable memory containing program code operable to be executed by a computer in performing the method are also disclosed herein.

### CROSS-REFERENCE TO RELATED APPLICATIONS

This application claims the benefit of U.S. Provisional Patent Application Ser. No. 61/187,398 for an APPARATUS FOR ASSESSING AND METHOD FOR DELIVERING AN EQUIPMENT UPGRADE PROPOSAL, filed on Jun. 16, 2009, which is hereby incorporated by reference in its entirety.

### BACKGROUND OF THE DISCLOSURE

1. Field of the Disclosure

The invention relates generally to an apparatus and method in which at least part of an equipment upgrade proposal can be delivered to a customer and then assessed by the customer independently.

2. Description of Related Prior Art

When an operator of equipment is solicited with proposals to upgrade its equipment, the operator can accept the proposal or allow its equipment to continue to operate with only routine maintenance. For example, the operator of a fleet of vehicles can consider a proposal to upgrade the engines of the vehicles. The upgrade may be the replacement of existing engines with new engines or may be the replacement of one or components of the engines with new components. The upgrade may result in improved efficiency of each engine, greater power output, and/or enhanced reliability. Operators of industrial machines can similarly be solicited with proposals to upgrade machines.

### SUMMARY OF THE DISCLOSURE

In summary, the invention is a computer-implemented method for delivering an equipment upgrade proposal. The computer-implemented method includes the step of receiving input related to the nature of use of current equipment. The computer-implemented method also includes the step of estimating a payback period based on the received input. The computer-implemented method also includes the step of displaying textual information detailing the payback period for consideration by a potential customer. The computer-implemented method also includes the step of generating a plurality of different screen displays including at least one screen display during the receiving step and at least one screen display during the displaying step. The computer-implemented method also includes the step of customizing at least one of the plurality of different screen shots based on information associated with the potential customer other than the input related to the nature of use of current equipment. The invention also covers an apparatus practicing the method and a readable memory containing program code operable to be executed by a computer in performing the method.

### BRIEF DESCRIPTION OF THE DRAWINGS

The patent or application file contains at least one drawing and one photograph executed in color. Copies of this patent or patent application publication with color drawings and a color photograph will be provided by the Office upon request and payment of the necessary fee.

FIG. 1 is a simplified flow diagram showing a method associated with the communication and evaluation of an equipment upgrade proposal;

FIG. 2 shows an exemplary accessory or mobile drive that can carry an executable program for evaluating an equipment upgrade proposal;

FIG. 3 is a first screen display of a first video sequence displayed on a computer monitor under the control of the executable program, wherein the first video sequence relates to an equipment upgrade proposal, but is not necessary for assessing the economic desirability of the equipment upgrade proposal;

FIG. 4 is a second screen display of the first video sequence;

FIG. 5 is a third screen display of the first video sequence;

FIG. 6 is a fourth screen display of the first video sequence;

FIG. 7 is a fifth screen display of the first video sequence;

FIG. 8 is a sixth screen display of the first video sequence;

FIG. 9 is a first screen display of a second video sequence displayed on a computer monitor under the control of the executable program, wherein the second video sequence takes the viewer through the internal structures of the piece of equipment to be upgraded;

FIG. 10 is a second screen display of the second video sequence;

FIG. 11 is a third screen display of the second video sequence;

FIG. 12 is a fourth screen display of the second video sequence;

FIG. 13 is a fifth screen display of the second video sequence;

FIG. 14 is a sixth screen display of the second video sequence;

FIG. 15 is a seventh screen display of the second video sequence;

FIG. 16 is an eighth screen display of the second video sequence;

FIG. 17 shows a screen displayed on a computer monitor under the control of the executable program, wherein the screen is for soliciting data from the potential customer;

FIG. 18 is a first comparison screen displayed on a computer monitor under the control of the executable program, wherein a side-by-side comparison of gauges for the current equipment and the equipment after upgrade is displayed;

FIG. 19 is a second comparison screen displayed on a computer monitor under the control of the executable program, wherein a side-by-side comparison of gauges for the current equipment and the equipment after upgrade is displayed;

FIG. 20 is a third comparison screen displayed on a computer monitor under the control of the executable program, wherein a side-by-side comparison of gauges for the current equipment and the equipment after upgrade is displayed;

FIG. 21 is a fourth comparison screen displayed on a computer monitor under the control of the executable program, wherein a side-by-side comparison of gauges for the current equipment and the equipment after upgrade is displayed;

FIG. 22 is a display screen showing an exemplary graph that can be displayed on a computer monitor under the control of the executable program, wherein the graph displays economic data including payback period;

FIG. 23 is a second view of the display screen shown in FIG. 22;

FIG. 24 is a display screen of assumed data applied in combination with input data to generate when the graphs of FIGS. 22 and 23;

FIG. 25 is a display screen showing a first graph with a plurality of curves comparing current operating conditions relative to payload capacity with upgraded operating conditions;

FIG. 26 is a display screen showing a second graph with a plurality of lines comparing current operating conditions relative to payload capacity with upgraded operating conditions;

FIG. 27 is a display screen showing third and fourth graphs each with a plurality of curves comparing current operating conditions relative to payload capacity with upgraded operating conditions; and

FIG. 28 is a display screen showing third and fourth graphs each with a plurality of curves comparing current operating conditions relative to payload capacity with upgraded operating conditions.

### DETAILED DESCRIPTION

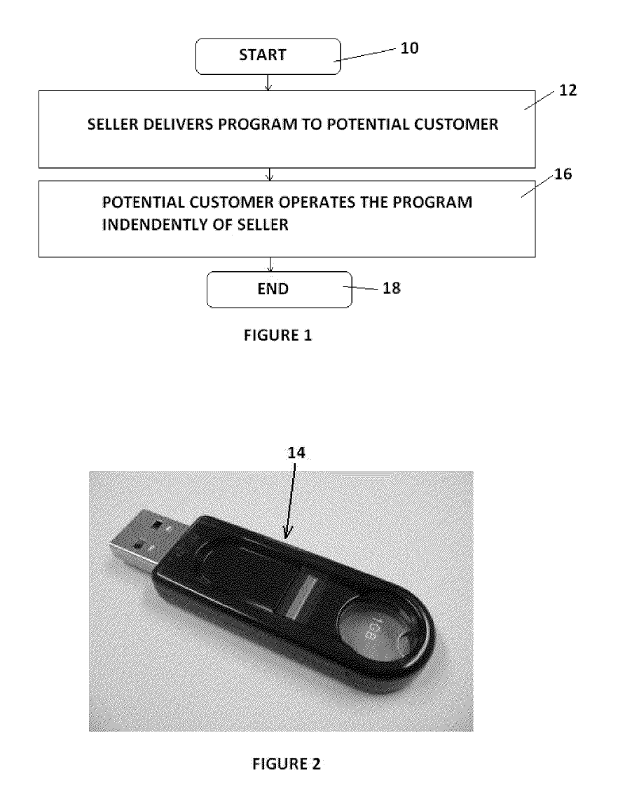

As set forth above, FIG. 1 is a simplified flow diagram showing a method associated with the communication and evaluation of an equipment upgrade proposal. The steps shown in FIG. 1 can be taken substantially at the beginning of a sales process, a process that can culminate in the sale of products and/or services or can culminate in the rejection of the equipment upgrade proposal. These steps are enhanced relative to what is currently done and can increase the likelihood of a sale.

The program starts at step 10. At step 12, the seller can deliver a program to the potential customer. The program can be delivered by first placing or encoding the program on computer-readable medium of a transferable storage device and then transferring the storage device to the potential customer. The storage device can be a CD or a memory card or an accessory drive or any other form of storage device. FIG. 2 shows an exemplary accessory drive 14 that can carry the program. Alternatively, the program can be communicated to the seller electronically, such as by email. Alternatively, the program can be made accessible to the potential customer through a network such as the internet.

An exemplary embodiment of a program that can be delivered to a potential customer will be described in greater detail below. However, generally, the program can accomplish several things. First, the program can have the capacity to receive input from the potential customer. For example, the program can solicit and receive data relating to how the potential customer currently operates its equipment. This opportunity to enter data allows the customer to test the equipment upgrade proposal under various scenarios to determine the set of circumstances under which the equipment upgrade proposal is most desirable.

Second, the program can generate video sequences that relate to the equipment upgrade proposal, but are not necessary for assessing the economic desirability of the equipment upgrade proposal. For example, the program can generate a beginning or opening video sequence prior to the input of data that shows the equipment in operation. The video sequence can include images particularly associated with the potential customer, such as an overhead view of the potential customer's facility. Sounds associated with the potential customer and the equipment can be emitted during the video. Such a video and sounds sequence can be an enjoyable experience for the potential customer, an experience that induces the potential customer to be more comfortable with the program and also to more frequently execute the program.

Third, the program can generate video sequences that relate to the specific technical nature of the upgrade. For example, if the upgrade involves replacing components of an engine, the program can be operable to generate a video sequence that takes the viewer through the internal structures of the engine. The video sequence can show the viewer the specific technical nature of the upgrades.

Fourth, the program can generate output in a side-by-side comparison of operating conditions for the equipment. One side of the comparison can display current operating conditions and the other side can display the improvements that could be enjoyed if the equipment upgrade proposal is accepted. For example, the program could generate a split screen showing gauges of the equipment on both sides. On a first side, the gauges could display values corresponding to current operating performance. On a second side, the gauges could display values corresponding to operating performance if the equipment upgrade proposal is accepted. The gauges displayed on the monitor screen can appear identical to gauges on the equipment.

Fifth, the program can generate an output display of economic data, such as payback period. The program can include stored data and, in combination with the potential customer's input data, can execute mathematical operations to generate graphs, tables, or any other form of presentation that shows cost, payback period, or other data. The term “payback period” in business and economics refers to the period of time required for the return on an investment to equal the sum of the original investment. Payback period can be particularly relevant in situations in which a piece of equipment can be upgraded or allowed to continue operating at an existing level of efficiency and/or output.

The capabilities of the program set forth above can be arranged in a particular order to increase the likelihood that the equipment upgrade proposal will be accepted. An initial video sequence that relates to the equipment upgrade proposal, but is not necessary for assessing the economic desirability of the equipment upgrade proposal, can occur first so that the potential customer is drawn to the program, but not overwhelmed with rigorous intellectual demands. Next, a video sequence can occur that takes the viewer through the internal structures of the engine. The video sequence can show the viewer the specific technical nature of the upgrades. This second event in the program, like the first, need not overwhelm the potential customer with rigorous intellectual demands. However, the second event can be more informative than the first event. Thus, the potential customer's attention is being increasingly focused on the equipment upgrade proposal. A third event occurring in the program can be a screen soliciting data from the potential customer. The amount of data or the number of data categories for data input can be selected based on the nature of the equipment, the nature of the upgrades, or any other consideration. A fourth event occurring in the program can be a split screen with gauges displaying values corresponding to current operating performance and gauges displaying values corresponding to the operating performance that could be enjoyed if the equipment upgrade proposal is accepted. Thus, the potential customer can be shown how the upgrade could improve efficiency/output/power during run time of the equipment. These benefits would be the immediate benefits enjoyed by accepting the equipment upgrade proposal. A fifth event occurring in the program can be display output of economic data, such as payback period. Thus, after viewing immediate benefits, the potential customer can be provided with a long term view of the benefits that could be enjoyed by accepting the equipment upgrade proposal. It is noted that the order of events set forth above is an example and that other arrangements (events and order of events) can be applied.

At step 16, the potential seller can operate the program independently of the seller. The method illustrated by FIG. 1 can allow the potential customer to evaluate the equipment upgrade proposal from various perspectives without well-meaning but undesirable interference from the seller. The potential customer can test the equipment upgrade proposal under various scenarios to determine the set of circumstances under which the equipment upgrade proposal is most desirable. The method can allow the potential customer to evaluate the equipment upgrade proposal at his or her leisure. The process can end at step 18. A possible additional step subsequent to step 18 could be the potential customer's acceptance of the equipment upgrade proposal.

An exemplary equipment upgrade proposal and program will now be described. It is noted that this description may be a disclosure of one or more inventions. This provisional patent application discloses what has been developed and does not expressly or implicitly assert that only one invention is disclosed or that the example below is the only way of practicing any invention that is disclosed herein.

An exemplary equipment upgrade proposal can relate to the upgrade of turbine engines for operating aircraft, such as the C-130. Each C-130 includes four turbine engines. An exemplary upgrade of these turbine engines can be to replace various components of the turbine engine. The replacement of these components can result in improvements (declines) in turbine inlet temperature and fuel consumption.

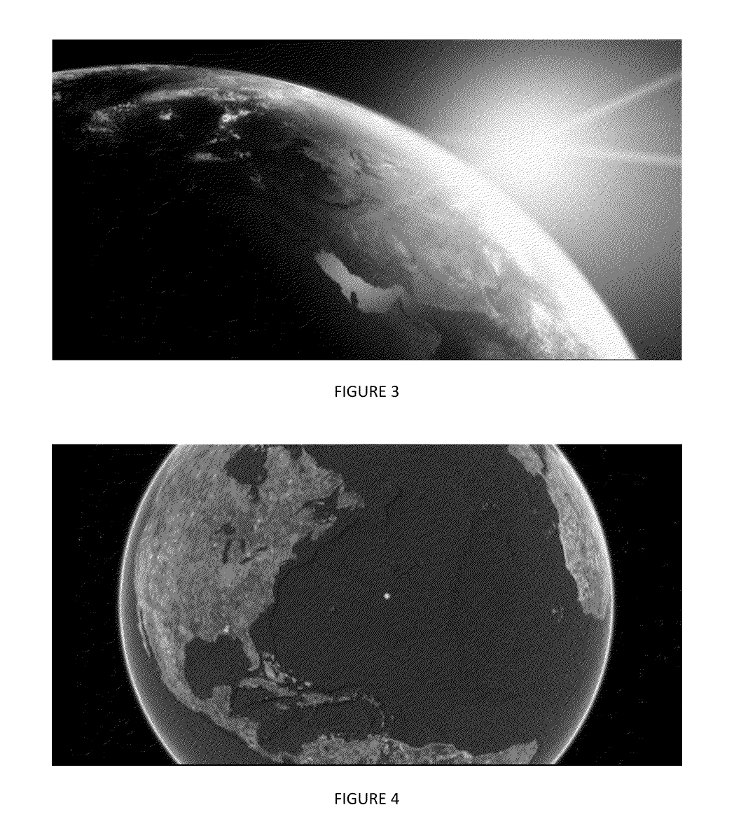

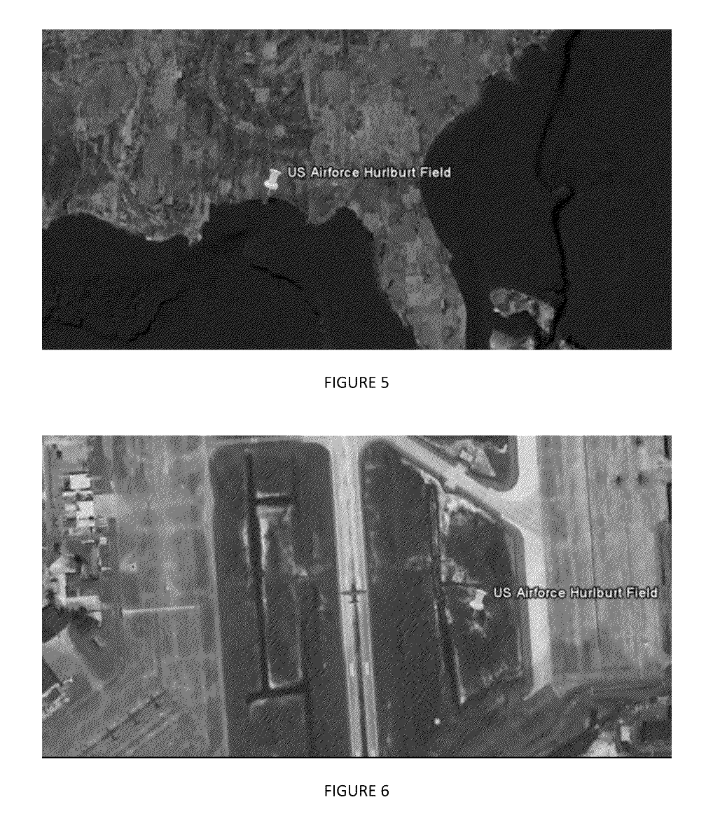

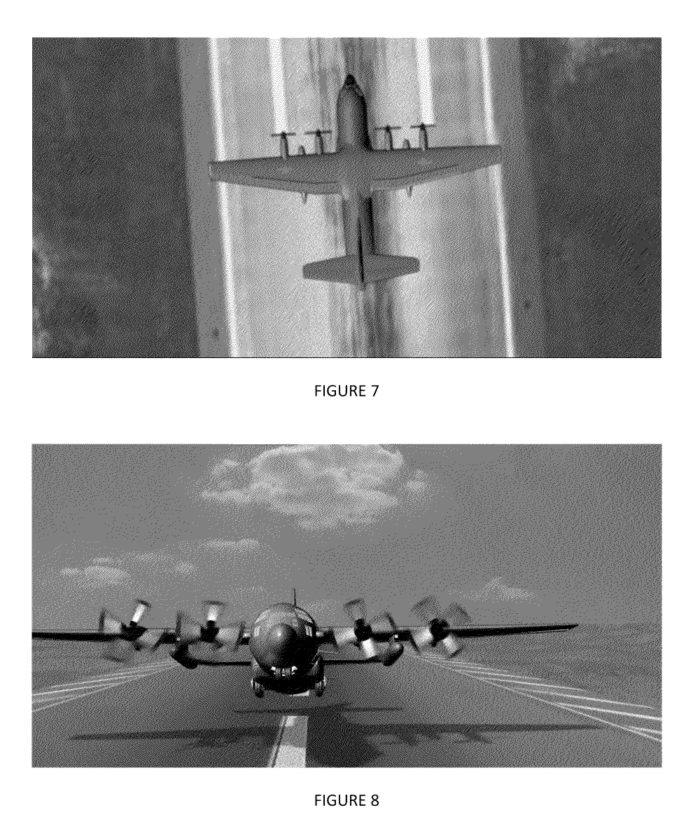

The seller of the equipment upgrade proposal can transfer a copy of an executable program to a potential customer. When the exemplary program is carried out on a computer, a video can be displayed on the monitor associated with the computer and sounds associated with the video can be emitted from speakers associated with the computer. The exemplary video can initially show the Earth and progressively narrow focus to the geographic location of the potential customer. The focus can further narrow on a C-130 aircraft taxiing on a runway. The aircraft can be shown with colors, indicia, flags, or any other visual symbol associated with the potential customer. FIGS. 3-8 show a progression of images that can be shown during the first video sequence of the exemplary program. During the video, sounds such as a national anthem can be emitted from the speakers as the viewpoint narrows focus from the Earth to the aircraft. The sounds of the aircraft can also be emitted. This combination of video and sound can resonate with the potential customer and promote the potential customer's interest in continuing the operation of the program. Also, the first sequence of video and sound requires no rigorous intellectual demands of the viewer. The visual and auditory information is experienced and the viewer is not required to make a decision, obtain data for input, or remember details of what is being presented.

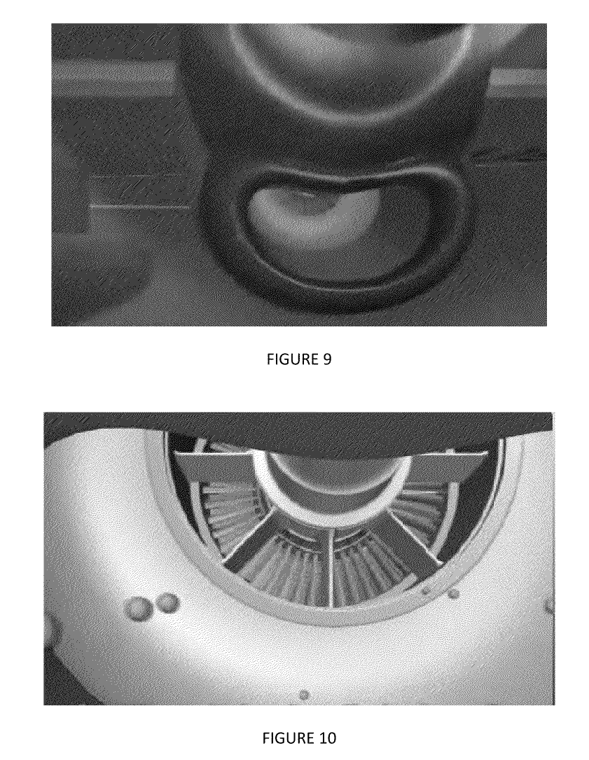

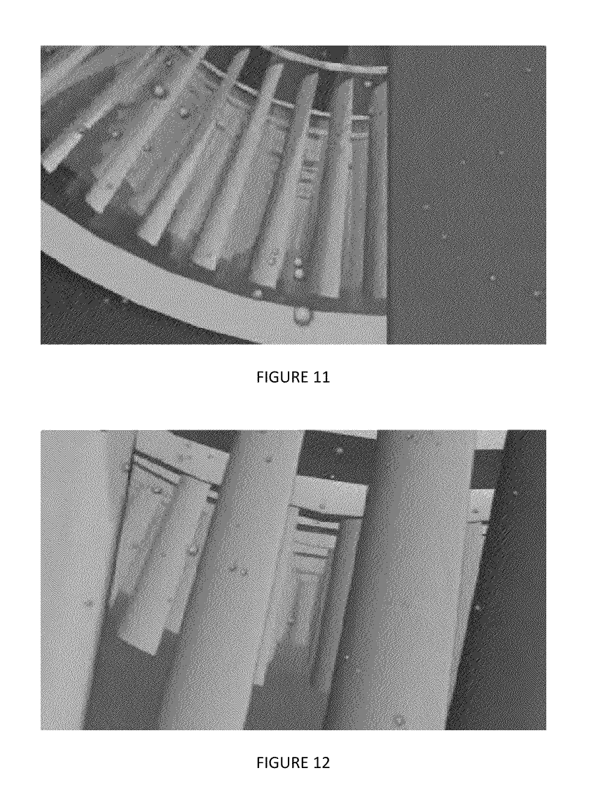

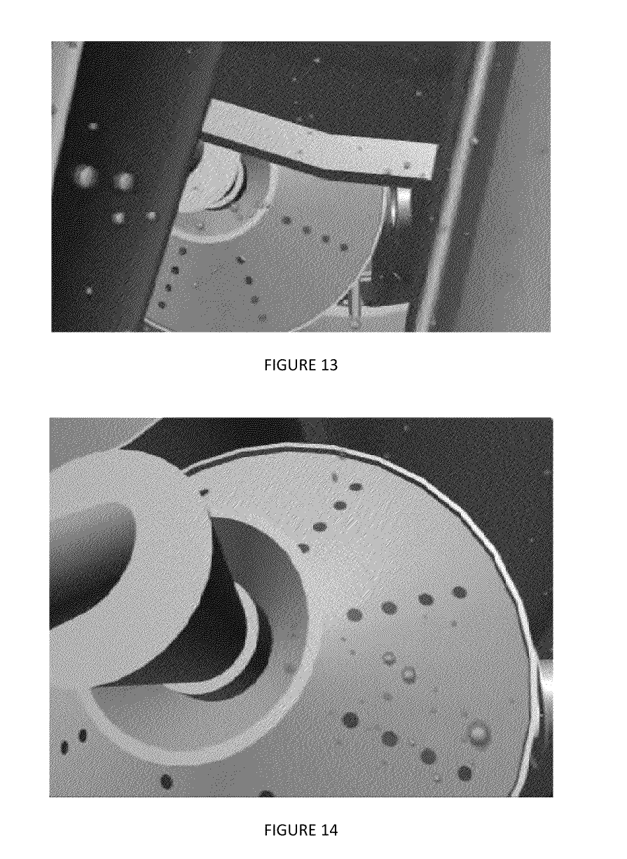

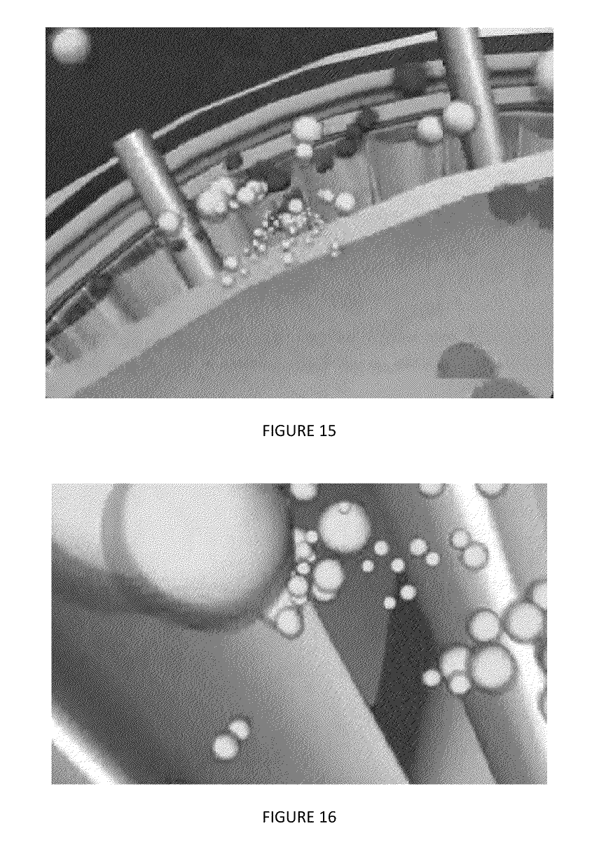

Next, a second video and sound sequence can be emitted by the computer under the direction of the program. The second sequence can take the potential customer through the internal structures of the turbine engine. At various locations where upgrades will occur, the video sequence can hold passage through the engine and momentarily focus on the specific internal structures that will be upgraded. This second event in the program can be more informative that the first, but need not overwhelm the potential customer with a high level of detail about the structural upgrades. FIGS. 9-16 show a progression of aft-viewing images that can be shown during the second event of the exemplary program. FIG. 9 is a view looking into a turbine engine. FIG. 10 is a view downstream of the inlet of the turbine engine and upstream of the compressor section. FIG. 11 is a view immediately upstream of the compressor section. FIG. 12 is a view in the compressor section. FIG. 13 is a view at an exit of the compressor section, showing the dome panel downstream. FIG. 14 is a view downstream of the compressor section and upstream of the dome panel. FIG. 15 is a view at an aft end of a combustor section, showing the turbine section downstream. FIG. 16 is a view at an exit of the turbine section.

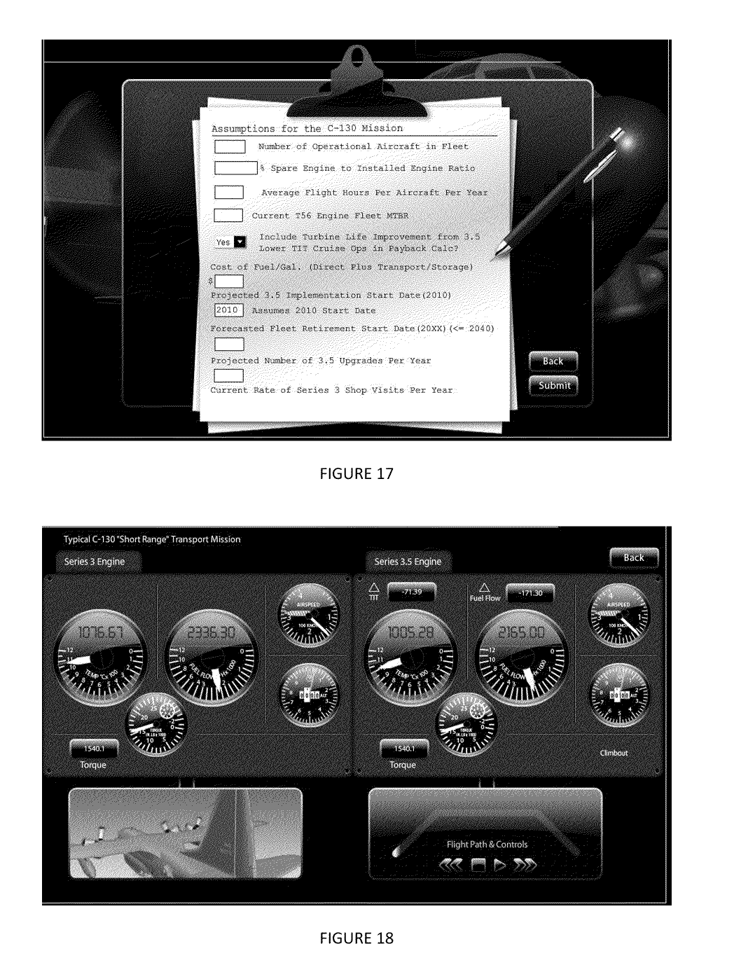

The executable program can then query the potential customer for data input. The computer running the program can thus receive input related to the nature of use of current equipment. FIG. 17 shows a display screen according to the exemplary program for soliciting data and receiving input. The amount of data or the number of variables solicited from the potential customer can vary as desired. The data corresponds to how the potential customer currently operates its equipment. This opportunity to enter data allows the customer to test the equipment upgrade proposal under various scenarios to determine the set of circumstances under which the equipment upgrade proposal is most desirable. Embodiments of the invention can accommodate an unlimited number of clients. A client screen can be included that dynamically paginates to account for all clients in each application.

Referring now to FIG. 17, the exemplary program solicits the number of aircraft in the fleet of the potential customer. This information is useful in determining the overall cost of the upgrade as well as the payback period. The exemplary program also solicits the ratio between spare engines and installed engines. Generally, the operator will desire to keep aircraft flying at all times, so upgrades can be applied to spare engines first or, alternatively, installed engines will be swapped with spare engines and then upgraded. The percentage of spare engines relates to the time period required to complete the upgrade and therefore relates to payback period.

The exemplary program also solicits average flight hours per year. This information is useful for determining payback period. The greater the flight hours per year, the sooner payback of the upgrade can be enjoyed. The exemplary program also solicits the “Current T56 Engine Fleet MTBR.” The term “T56” is a reference to the turbine engine to be upgraded in the exemplary equipment upgrade proposal. MTBR is an acronym for mean time between removal. This value relates to how many hours of operation pass before the turbine engine is removed and overhauled. The need to overhaul is determined by visual inspection of various parts of the turbine engine. This value reflects how hard the engine is being pushed. The engine may be operating in a harsh environment or the engine may be regularly pushed to its operational limit by the potential customer. This information is useful in determining payback period.

The exemplary program also queries the potential customer: Include Turbine Life Improvement from 3.5 Lower Turbine Inlet Temperature Cruise Ops in Payback Cal? The number 3.5 refers to the designation of the upgraded turbine engine configuration. This query is asking the potential customer if it will choose to apply the upgrade to increase the life of the equipment or if it will apply the upgrade to increase the performance of the equipment to operate. This information is useful in determining payback period.

The exemplary program also solicits the cost of fuel, the start date of the upgrade implementation, the forecast retirement date of the fleet, and the number of engines that will be upgraded each year. This information is useful in determining payback period. The final category of information is the current rate of series 3 shop visits per year. The term “series 3” refers to the designation of the current turbine engine configuration. The current rate of “series 3” shop visits can be calculated by the program based on the information input in the fields described above. The calculated number can be noted and confirmed by the potential customer.

Embodiments of the invention can allow a potential customer to vary yearly data, such as Fuel Cost, Fuel Burn Delta, etc. This data can be updated by the customer without taking the application back into programming year after year.

The program can also include predetermined or assumed data. This data in the exemplary program will be discussed in greater detail below. The data input by the potential customer and the assumed data can be subjected to algorithms by the program to generate two forms of output. A first form of output can be real-time data showing how engine operating conditions will improve upon completion of the upgrade. The exemplary program can cause the monitor to display a side-by-side comparison of gauges. In FIG. 18, the gauges to the left are similar to gauges in the aircraft and display information corresponding to the current (non-upgraded) engine. A temperature gauge measuring turbine inlet temperature and a fuel flow gauge are the largest gauges. To the right of the screen, similar gauges are shown displaying information corresponding to the upgraded engine. Gauges displaying values for air speed, altitude and torque can be the same on both the left and right side. The gauges can be dynamic, showing at least one measurement of a dimension, quantity, or mechanical accuracy of the current equipment during run time and a second gauge shows the at least one measurement of a dimension, quantity, or mechanical accuracy of upgraded equipment during run time.

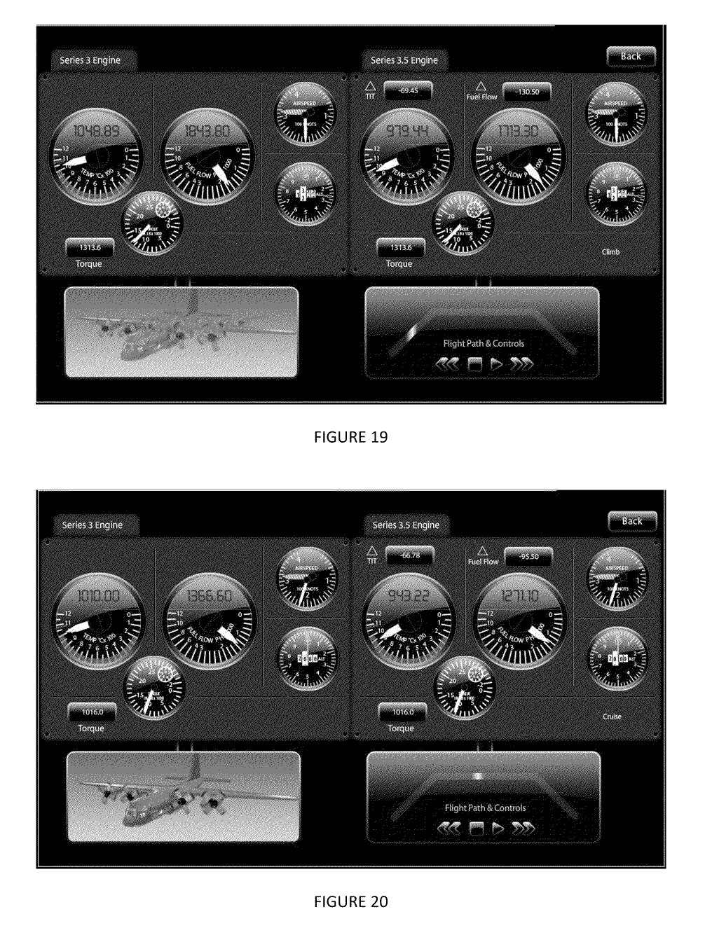

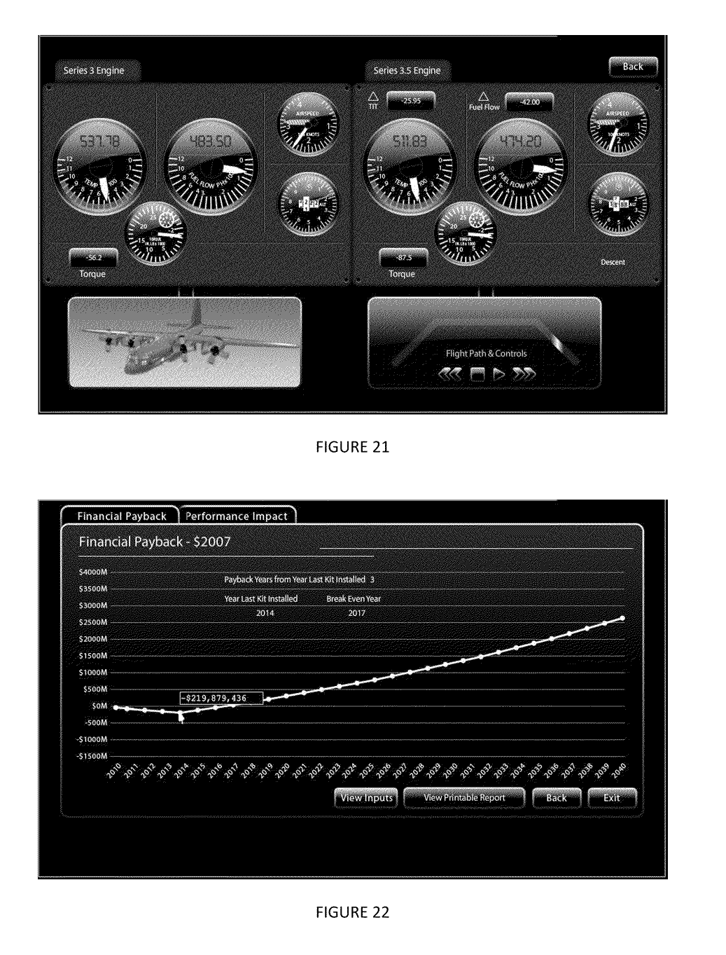

FIGS. 18-21 also show that the screen displays a graph correlating the operating conditions of both upgraded and non-upgraded engines at various stages of operation. In the bottom right corner, a generally red line of multiple segments represents a flight path of the aircraft. The left oblique segment represents the climbing portion of the flight path. The center horizontal segment represents the cruising altitude portion of the flight path. The right oblique segment represents the descending portion of the flight path. The multi-segment line is white where the position along the flight path correlates with the operating conditions displayed by the gauges.

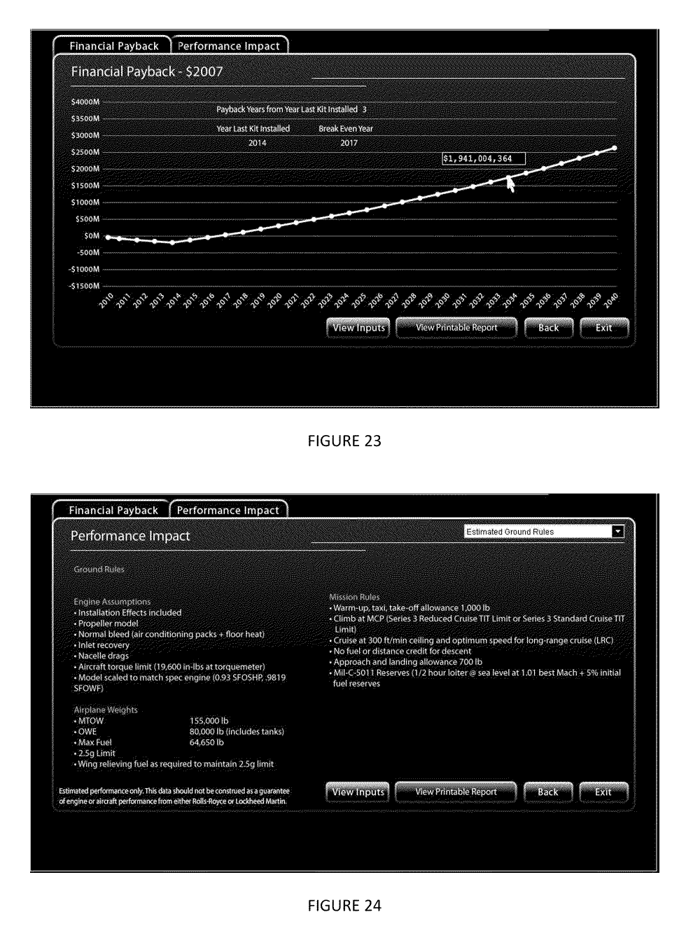

A second form of output of the exemplary program can be economic data, such as payback period. Thus, after viewing immediate benefits, the potential customer can be provided with a long term view of the benefits of accepting the equipment upgrade proposal. FIGS. 22 and 23 show a graph that can be displayed by a monitor under the control of the executable program. Each point along the line can provide specific data related to payback. FIG. 22 indicates that the maximum level of investment will be achieved in the fourth year of the exemplary upgrade. FIGS. 22 and 23 indicate that payback will occur in the seventh year of the exemplary upgrade. In FIGS. 22 and 23, the y-axis shown in the graphs can be predetermined or fixed, or can be dynamic. Changing the scale of the y-axis in response to data entered by a customer allows for a more dramatic payback curve.

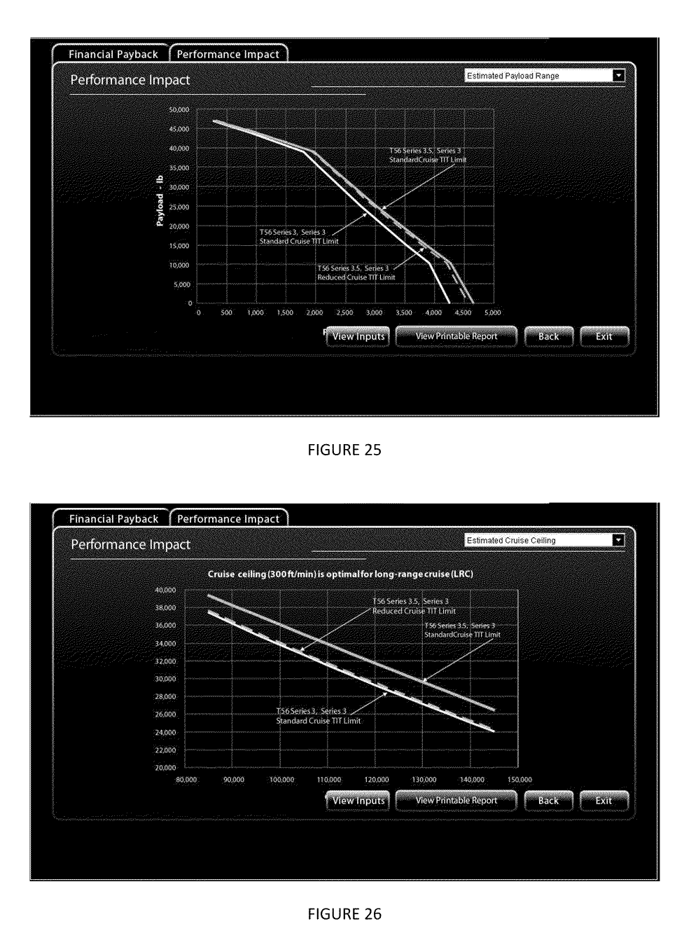

The display of FIG. 23 includes a tab marked “Performance Impact,” which relates to aircraft performance. FIG. 24 shows the displayed screen when this tab is selected. Assumptions for all aircraft and engine parameters that will affect aircraft performance are displayed in this screen. In the upper right-hand corner, a pull down menu is accessible by the potential customer to obtain further data output. The first option on the pull down menu is the Estimated Ground Rules, which are shown in FIG. 24. A second option from the pull down menu can be Estimated Payload Range, as shown in FIG. 25. In FIG. 25, the white represents the current payload range. The green and dashed line represents the improved payload range with decreased turbine inlet temperature. Operating along this line, the operator will enjoy improved payload capacity while also enjoying reduced turbine inlet temperature. The solid green line represents an optional improved payload range without decreased turbine inlet temperature. Operating along this line, the operator will enjoy even larger payload capacity, at the expense of the turbine inlet temperature remaining at current levels. In other words, the solid green line represents applying the upgrades to maximize performance at the expense of time interval between removal.

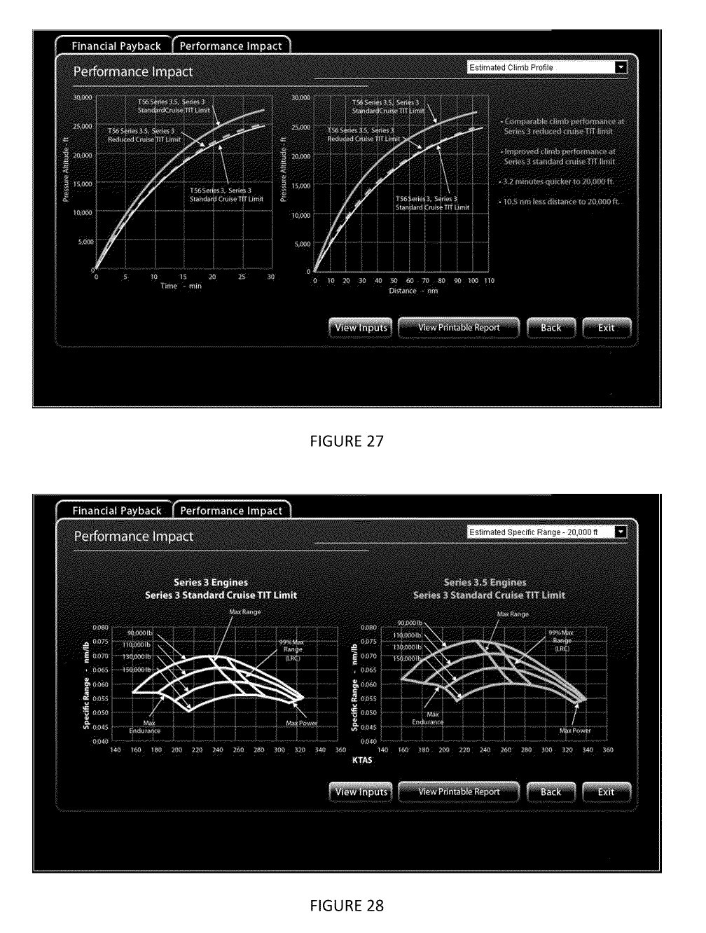

A third option from the pull down menu can display the Estimated Cruise Ceiling over various gross weights, as shown in FIG. 26. A fourth option from the pull down menu can display the Estimated Climb Profile over various times and distances, as shown in FIG. 27. A fifth option from the pull down menu can display the Estimated Range at a specific altitude, as shown in FIG. 28. The lines in FIG. 26—(white, dash green and solid green) are analogous to the lines in FIG. 25. Other options can be provided by the executable program.

The executable program described above can be provided to a potential customer for evaluation of an equipment upgrade proposal. The executable program includes theatrical elements as well as economic tools that are both tailored to the potential customer. The exemplary embodiment of the invention is superior to one-way, 2-Dimensional pitch presentations. These presentations do not provide the opportunity for instant, dynamic or customer-unique data, interaction or personalized feedback.

The exemplary embodiment of the broader invention can be constructed using Adobe's Flash CS3 platform and the coding language Actionscript 2.0. The primary component for application development can be Adobe Flash Framework and Actionscript Coding Language. Other technologies that could be potentially used, such as Adobe Flex, AIR, or any other software built in the Adobe SWF specification; Adobe Director and Lingo coding language, Microsoft Silverlight; Web-based or application-based coding language such as JAVA, JavaFX, Microsoft.NET, AJAX, Javascript, PHP, ColdFusion, RoR, Suneido.

The financial payback calculation can be created with Microsoft Excel. Other technologies could be used. The payback formula applied in the program can be translated into Actionscript code to allow a graphical output of results, as well as printable html forms of customer data.

Three-dimensional images such as aircraft can be created using Autodesk Maya. Other technologies could be used, such as Autodesk applications, 3D Studio Max, Lightwave, Cinema 3D, custom-built/proprietary 3D modeling and animation applications, UniGraphics, and CAD software.

Animated satellite imagery can be created using Google Earth Pro. Other technologies could be used, such as Microsoft's Virtual Earth 3D, ArcGIS Explorer, DigitalGlobe, animated satellite imaging systems.

As set forth above, a plurality of different screen displays can be generated during operation of the program, including at least one screen display during the step of receiving customer input and at least one screen display during the step of displaying payback data to the customer. In the exemplary embodiment of the invention, at least one of the plurality of different screen shots are customized based on information associated with the potential customer other than the input related to the nature of use of current equipment.

One or more screen displays can be customized by showing the equipment to be upgrade in a particular operating environment and/or in operation. The equipment to be upgraded could be used in several different planes. Embodiments of the invention can be practiced where a potential customer is given access to a program that generates at least one screen display of the particular model of plane used/maintained by that potential customer. In the exemplary embodiment, the turbine engine to be upgraded can be shown mounted on an aircraft.

Embodiments of the invention can be practiced where a potential customer is given access to a program that generates a series of screen displays defining a video of the equipment in operation. The video can be generally unnecessary to the equipment upgrade proposal. In the exemplary embodiment, the video of the engines in the operating environment of the C-130 and operating by turning a propeller is generally not necessary for potential customer to evaluate the equipment upgrade proposal. However, video that is generally unnecessary can be desirable in that the video can stimulate the potential customer's interest in completing the program.

Alternatively, the video can be generally relevant to the equipment upgrade proposal. In the exemplary embodiment, the video in which the viewer passes through the engine can help explain the nature of the upgrades. Several of the individual screen displays are views internal or hidden of the equipment. The video can clarify to the potential customer the nature of the technical upgrades being proposed.

The exemplary embodiment can entertain a viewer of the plurality of screen displays with one or more screen displays that are unnecessary for the receiving, estimating and displaying steps. To entertain is to hold the attention of pleasantly or agreeably, to amuse. The beginning video sequences in which the potential customer's geographic location is the focus of a zoom, the equipment is shown operating in the potential customer's planes, and the planes are shown in flight are examples of first screen displays for entertainment for the potential customer. These video sequences are not required for the program to provide a payback period. In the exemplary embodiment, these video sequences can be viewed by the potential customer without requiring critical thinking on the part of the potential customer.

The exemplary embodiment also provides “second” screen displays that educate the potential customer. The video sequences that travel through the engine can educate the potential customer on the general technical nature of the upgrades being proposed.

A screen display can be “unnecessary” if it contains images, text, indicia, or any other viewable aspect that is not required for receiving input from the customer, for estimating the payback period, or for displaying details of the payback period to the customer. In embodiments of the invention, none of the viewable aspects on a particular screen display may be unnecessary for receiving, estimating and displaying. For example, in the exemplary embodiment, the screen displays in which the potential customer's location is the subject of a zoom are not necessary for receiving input, estimating payback, and displaying data associated with payback. In other embodiments, a portion of a particular screen display may be unnecessary for receiving, estimating and displaying. For example, in the exemplary embodiment, the image/video of the aircraft at the bottom-right corner in FIGS. 18-21 is not necessary for receiving input, estimating payback, and displaying data associated with payback whereas the gauge displays could be necessary to help the potential customer understand the full extent of upgrade performance and payback. In still other embodiments, none of the viewable aspects on a first screen display may be unnecessary for receiving, estimating and displaying and a portion of a second screen display may be unnecessary for receiving, estimating and displaying. For example, in the exemplary embodiment, all the viewable aspects in FIGS. 22-28 relate to displaying payback data. The necessity of a particular viewable aspect of a screen display or of an entire screen display can be assessed based on the functionality of the viewable aspect in displaying numerical data related to payback. For example, the viewable aspects in FIG. 28 are not all numerical data (tabs, text, lines, buttons). However, these viewable aspects facilitate an orderly presentation of the numerical data.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. The right to claim elements and/or sub-combinations of the combinations disclosed herein is hereby reserved.

What is claimed is:

1. A computer-implemented method for delivering an equipment upgrade proposal comprising the steps of:
receiving input related to the nature of use of current equipment;
estimating a payback period based on the received input;
displaying textual information detailing the payback period for consideration by a potential customer;
generating a plurality of different screen displays including at least one screen display during said receiving step and at least one screen display during said displaying step; and
customizing at least one of the plurality of different screen shots based on information associated with the potential customer other than the input related to the nature of use of current equipment.

2. The computer-implemented method of claim 1 wherein said customizing step further comprises the step of:
producing at least one screen display of the current equipment in an operating environment associated with the particular customer.

3. The computer-implemented method of claim 1 wherein said customizing step further comprises the step of:
producing a series of screen displays defining a video of the current equipment in operation.

4. The computer-implemented method of claim 1 wherein said customizing step further comprises the step of:
producing at least one screen display of the current equipment in which the view is internal to the current equipment.

5. The computer-implemented method of claim 1 wherein said customizing step further comprises the step of:
producing a series of screen displays defining a video in which the viewer passes through the current equipment during operation.

6. The computer-implemented method of claim 1 wherein said customizing step further comprises the step of:
producing at least one screen display with gauges associated with the current equipment including a first set of gauges showing a measurement of a dimension, quantity, or mechanical accuracy of the current equipment and a second set of gauges showing a measurement of a dimension, quantity, or mechanical accuracy of upgraded equipment.

7. The computer-implemented method of claim 1 wherein said customizing step further comprises the step of:
producing a series of screen displays defining a video in which a first gauge shows at least one measurement of a dimension, quantity, or mechanical accuracy of the current equipment during run time and a second gauge shows the at least one measurement of a dimension, quantity, or mechanical accuracy of upgraded equipment during run time.

8. The computer-implemented method of claim 1 further comprising the step of:
emitting sound associated with one of the potential customer and the current equipment.

9. The computer-implemented method of claim 1 further comprising the step of:
emitting the sound of the current equipment in operation.

10. The computer-implemented method of claim 1 wherein said receiving step is further defined as:
receiving input related to the nature of use of current equipment directly from a potential customer.

11. The computer-implemented method of claim 1 wherein said receiving step is further defined as:
receiving input related to the nature of use of current equipment over a network.

12. The computer-implemented method of claim 1 further comprising the step of:
first providing one or more first screen displays that are unnecessary for said receiving, estimating and displaying steps for entertaining a viewer of the plurality of screen shots.

13. The computer-implemented method of claim 12 wherein said first providing step is executed before said receiving step.

14. The computer-implemented method of claim 12 further comprising the step of:
second providing one or more second screen displays that are unnecessary for said receiving, estimating and displaying steps for educating a viewer of the plurality of screen shots, the first screen displays being different than the second screen displays.

15. The computer-implemented method of claim 14 wherein said first and second providing steps are executed before said receiving step.

16. The computer-implemented method of claim 15 wherein said first providing step is executed before said second providing step.

17. An apparatus comprising:
a readable memory containing program code operable to be executed by a computer in performing the steps set forth in claim 1.

18. The apparatus of claim 17 wherein said readable memory is further defined as a flash drive.

19. The apparatus of claim 17 wherein said readable memory is further defined as being associated with a server.

20. An apparatus comprising:
a computer executing the steps set forth in claim 1.
